(19) United States
(12) Patent Application Publication
(10) Pub. No.: US 2012/0305117 A1
(43) Pub. Date: Dec. 6, 2012

(54) Lead-free valve of faucet and process of manufacturing same

(76) Inventor: Tsung-Min Huang, Changhua (TW)

(21) Appl. No.: 13/154,408

(22) Filed: Jun. 6, 2011

(51) Int. Cl. F16K 51/00; B21K 1/20

(52) U.S. Cl. 137/801; 29/890.126

(57) ABSTRACT

A lead-free valve of faucet and process of manufacturing same is provided. The faucet includes a valve comprising a stainless steel sleeve including a rim; a stainless steel cartridge including a stepped-diameter opening with the rim seated thereon, two opposite peripheral ports, and a soldered joint for joining the sleeve, the rim, and the cartridge together; a stainless steel stem secured to a handle and co-rotated therewith, the stem including a bottom tab; a plastic disc first retaining member including a slit; a ceramic oval second retaining member including two opposite cavities and a slot aligned with the slit, and the tab inserted through the slit into the slot to join the stem, the first retaining member, and the second retaining member together; a ceramic disc abutting member including two opposite, spaced through holes; and a plastic seat for urging the abutting member against the second retaining member.

### BACKGROUND OF THE INVENTION

1. Field of the Invention

The invention relates to faucets and more particularly to a faucet having a valve which is not only lead-free but also has both housing and stem being formed of stainless steel. The invention further more particularly relates to a process of manufacturing the lead-free valve.

2. Description of Related Art

A conventional valve 10 of a faucet is shown in FIG. 6. The valve 10 is made of ceramic and comprises a hollow cartridge 101 having external threads, a stem 102 rotatably sealingly disposed through the cartridge 101, an annular groove 103 disposed at one end of the stem 102 distal a handle (not shown) at the other end of the stem 102, a flow control member 104 also disposed at one end of the stem 102 below the groove 103, a hollow stop member 105 under the flow control member 104, and a fastening member 106 for fastening the stop member 105 from below. The flow control member 104 is secured to the stem 102. Thus, the flow control member 104 can be lifted or lowered by rotating the handle which in turn rotates the stem 102. For example, top edge of the flow control member 104 may enter to the groove 103 when lifting. As such, a gap is formed between the flow control member 104 and the stop member 105. As a result, fluid (e.g., water) may flow through the stop member 105, the gap, port(s) of the flow control member 104, and a spout (not shown) to exit the faucet.

Both the cartridge 101 and the stem 102 are formed of brass. About 2% lead is further added to each of the cartridge 101 and the stem 102 for changing its properties for manufacturing purposes. However, water flowing out of the faucet may be contaminated by the lead components of both the cartridge 101 and the stem 102 due to flow path through it. That is, the lead may release toxic chemicals which may be potential risks to human health and the environment.

There typical attempts to manufacture a lead-free, stainless steel valve of faucet. However, they all failed due to manufacturing difficulties as the present inventor is aware. Thus, the need for improvement still exists.

### SUMMARY OF THE INVENTION

It is therefore one object of the invention to provide a faucet comprising a valve body comprising a passageway therethrough, an internally threaded opening communicating with the passageway, and a spout at one end of the passageway; a valve comprising a stainless steel sleeve including an annular flange and a rim extending downward from the flange; a hollow, cylindrical, stainless steel cartridge including external threads extending from one end, a stepped-diameter opening surrounded by the external threads and with the rim seated thereon, two opposite peripheral ports proximate the other end and spaced from the external threads, a lead free annular soldered joint for joining the bottom of the sleeve, the rim, and one end of the cartridge, and a first O-ring put on the soldered joint; a stainless steel stem including a gear at one end, a threaded hole surrounding by the gear, a plurality of intermediate second O-rings, and a tab extending downward from the other end to be substantially flush with the ports wherein the stem is partially disposed in both the sleeve and the cartridge and has the gear exposed, and wherein a portion of the stem is further frictionally retained in the sleeve with the second O-rings being rotatably secured to the sleeve; a plastic, disc shaped first retaining member including a diametrical slit; a ceramic, oval second retaining member including two opposite, peripheral cavities and a slot wherein the first retaining member is complimentarily seated upon the second retaining member with the slit aligned with the slot, and the tab inserted through the slit into the slot to lockingly join the stem, the first retaining member, and the second retaining member together; a ceramic, disc shaped abutting member including two opposite, spaced through holes; and a plastic, ring shaped seat for urging the abutting member against the second retaining member wherein the cartridge is supported by the seat; and a handle comprising a hole with gear-like threads engaged with the gear; wherein the handle is secured to the stem by driving a fastener through the handle into the threaded hole; wherein the seat is fastened in the valve body by threadedly securing the external threads to the internally threaded opening so as to anchor the valve in the valve body; and wherein a rotation of the handle rotates the stem which in turn rotates the second retaining member to either communicate the cavities with the through holes in order to flow fluid through the valve or block the communication of the cavities with the through holes.

The above and other objects, features and advantages of the invention will become apparent from the following detailed description taken with the accompanying drawings.

### BRIEF DESCRIPTION OF THE DRAWINGS

FIG. 1 is an exploded view of a faucet according to the invention;

FIG. 2 is an exploded view of the valve;

FIG. 3A is a longitudinal sectional view of the assembled valve;

FIG. 3B is a bottom view of the abutting member and the second retaining member of FIG. 3A taken along a line with an arrow at either end in FIG. 3A;

FIG. 4 is a longitudinal sectional view of the faucet with the valve being open to let fluid flow;

FIG. 5 is a flow chart illustrating a process of manufacturing the lead-free valve of faucet according to the invention; and

FIG. 6 is a longitudinal sectional view of a typical valve of faucet.

### DETAILED DESCRIPTION OF THE INVENTION

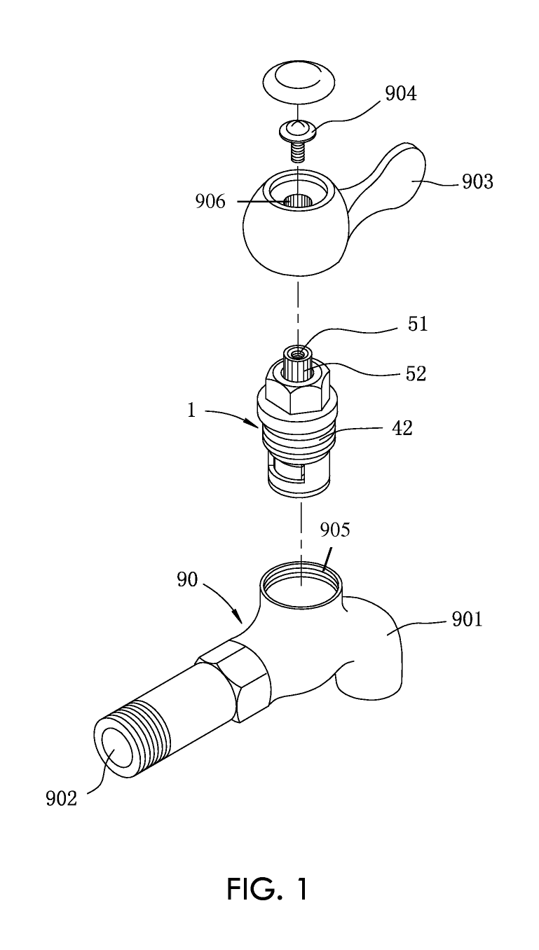

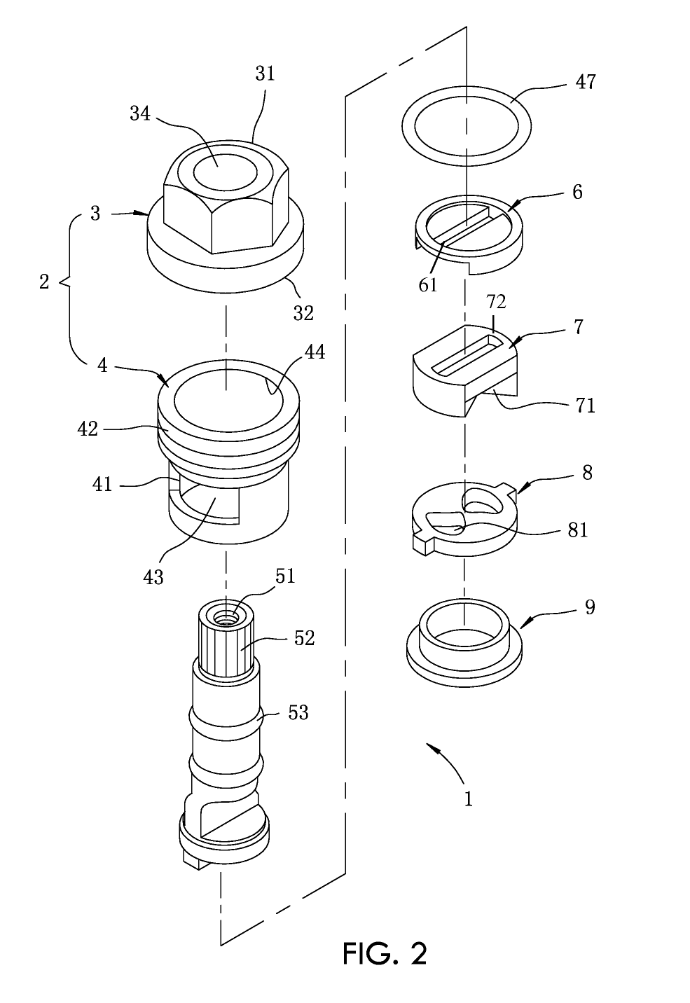

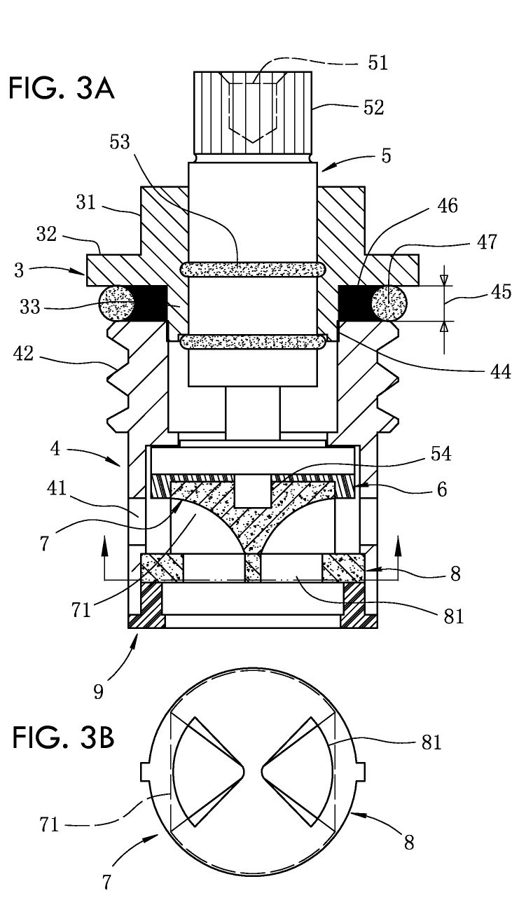

Referring to FIGS. 1 to 4, a faucet in accordance with the invention comprises a valve body 90 with a valve 1 disposed therein. The valve body 90 comprises a spout 901, a passageway 902 through the valve body 90 so that fluid (e.g., water) may flow from a source (not shown) to the spout 901 via the valve 1, an internally threaded opening 905 on top, and a single lever handle 903. The valve 1 as the subject of the invention will be discussed in detail below.

The valve 1 comprises a housing 2 formed of stainless steel. The housing 2 comprises an upper sleeve 3 and a lower cylindrical cartridge 4. The sleeve 3 comprises a hexagonal head 31, an annular flange 32 below the head 31, a rim 33 extending downward from the bottom, the rim 33 having an uneven bottom, and a bore 34 inside the sleeve 3. The cartridge 4 has both ends open and comprises two lower, opposite peripheral ports 41, upper external threads 42, a bore 43 inside the cartridge 4, and a stepped-diameter top opening 44. An annular gap 45 is formed between the flange 32 and the top of the cartridge 4 when the rim 33 is seated upon the opening 44 to be positioned. An annular soldered joint 46 is lead free and used to join the sleeve 3 and the cartridge 4 together. An O-ring 47 is put on the soldered joint 46 for leak prevention purpose.

A stem 5 is formed of stainless steel and comprises a threaded top hole 51, upper gear 52, two spaced, intermediate O-rings 53, and a tab 54 extending downward from the bottom. The O-rings 53 are rotatably fastened in an intermediate portion of the bore 34 and the bottom of the rim 33 respectively. Both the gear 52 and the hole 51 are disposed upwardly of the sleeve 3. The tab 54 is disposed in the cartridge 4 substantially flush with tops of the ports 41. A first retaining member 6 is formed of plastic and shaped as a disc. The first retaining member 6 comprises a diametrical slit 61.

A second retaining member 7 is formed of ceramic and shaped as an oval racing track when viewed from top. The second retaining member 7 comprises two opposite cavities 71 on both sides of its rectangular portion respectively, and a slot 72 on top. The cavities 71 do not communicate each other. The first retaining member 6 can be complimentarily seated upon the second retaining member 7 with the slit 61 aligned with the slot 72. Thus, the tab 54 may insert through the slit 61 into the slot 72 for lockingly joining the stem 5, the first retaining member 6, and the second retaining member 7 together.

A disc shaped abutting member 8 is formed of ceramic. The abutting member 8 comprises two opposite, spaced through holes 81 substantially shaped as a circular sector. A plastic ring shaped seat 9 is provided to urge the abutting member 8 against the bottom of the second retaining member 7 from below. Also, the bottom of the cartridge 4 is supported by the seat 9. The cavities 71 may align with the through holes 81 for communication or not in response to a rotation of the second retaining member 7 due to a rotation of the stem 5 as detailed later.

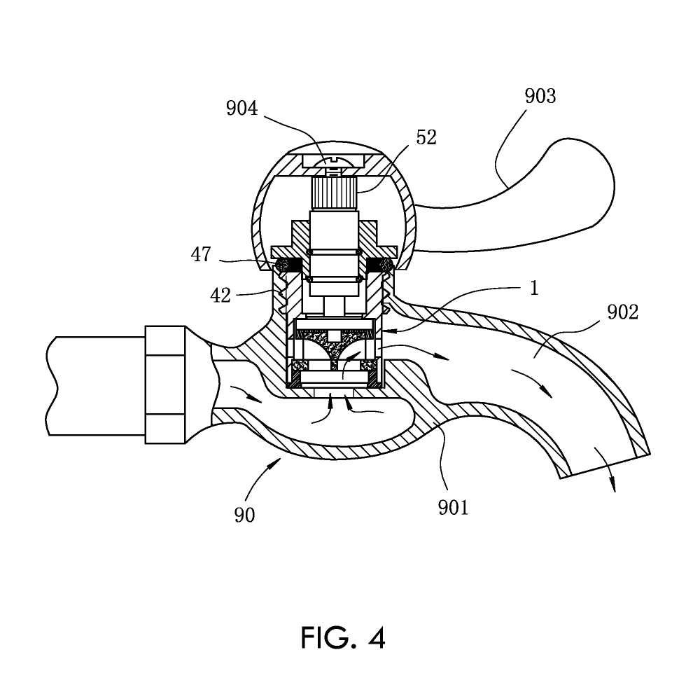

The seat 9 is fastened in the valve body 90 with the external threads 42 threadedly secured to the internally threaded opening 905. As a result, the valve 1 is anchored in the valve body 90. A screw 904 is used to secure the handle 903 to the stem 5 by driving through a hole 906 with gear-like threads of the handle 903 into the threaded top hole 51. Thus, a rotation of the handle 903 may rotate the stem 5 due to the meshing engagement of the hole 906 with the gear 52. And in turn, the second retaining member 7 may rotate to completely communicate the cavities 71 with the through holes 81, completely block the communication of the cavities 71 with the through holes 81, or partially communicate the cavities 71 with the through holes 81 during a flow control operation. As shown in FIG. 4, Fluid (e.g., water) may from through a distal portion of the passageway 902, the seat 9, the through holes 81, the cavities 71, and the ports 41, a proximal portion of the passageway 902, and the spout 901 to leave the faucet.

It is envisaged by the invention that dispensed water will not be contaminated by lead by releasing toxic chemicals because the faucet including the valve 1 is lead free.

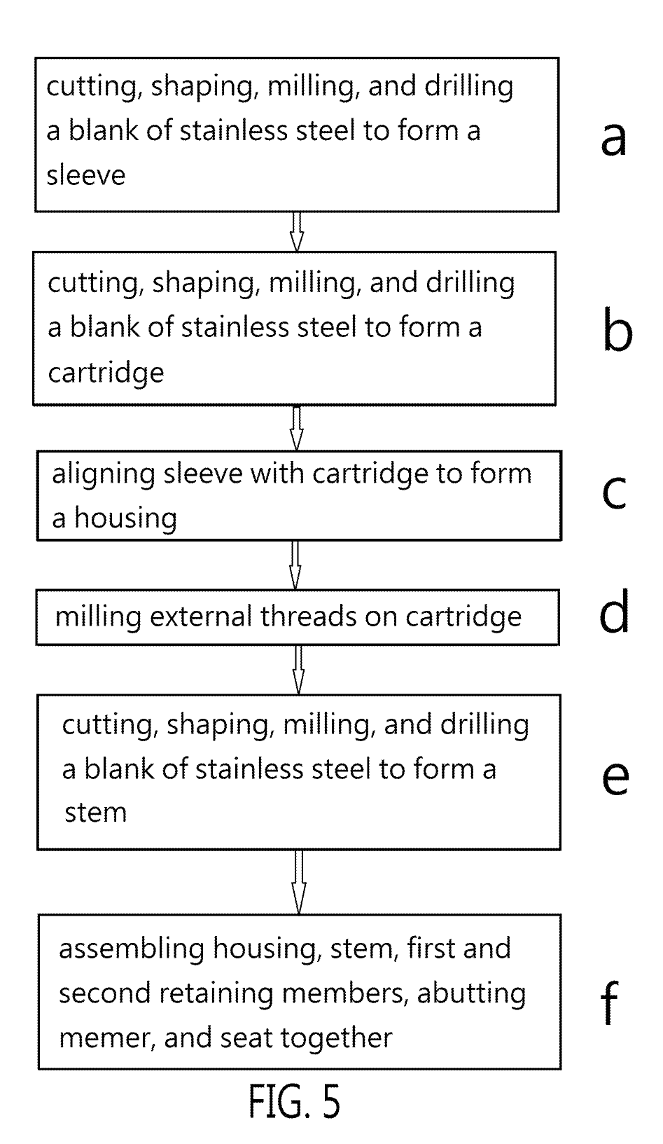

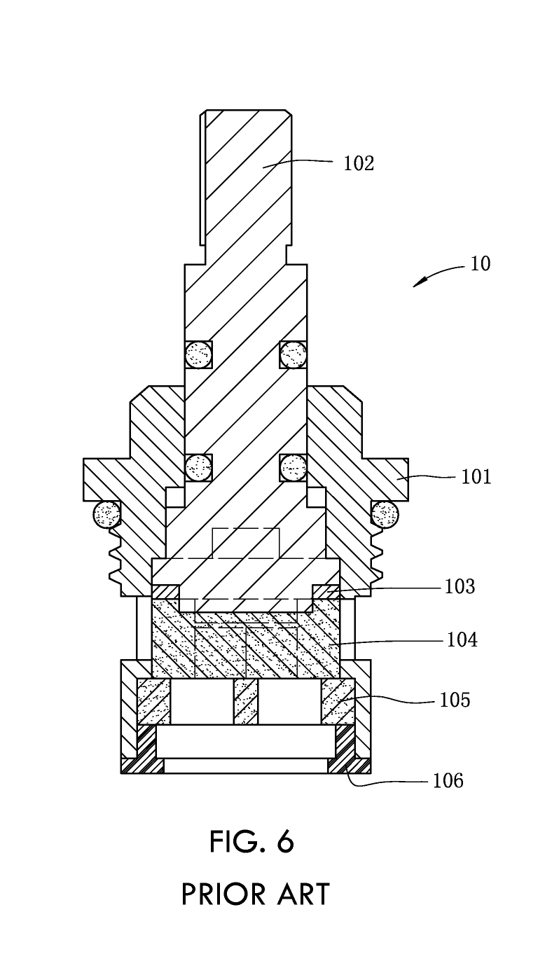

Referring to FIG. 5, a process of manufacturing the above lead-free valve 1 of faucet in accordance with the invention is illustrated in conjunction with FIGS. 1 to 4. The process comprises the following steps:

Step a: Cutting, shaping, milling, and drilling a blank of stainless steel to form a sleeve 3 with a rim 33.

Step b: Cutting, shaping, milling, and drilling a blank of stainless steel to form a cartridge 4 with a bore 44.

Step c: Aligning the sleeve 3 with the cartridge 4 to form a housing 2.

Step d: Milling external threads 42 on the external surface of an upper portion of the cartridge 4 so that the cartridge 4 may be fastened in a valve body 90 by threading.

Step e: Cutting, shaping, milling, and drilling a blank of stainless steel to form a stem 5.

Step f: Assembling the housing 2, the stem 5, a first retaining member 6, a second retaining member 7, an abutting member 8, and a set 9 together.

While the invention has been described in terms of preferred embodiments, those skilled in the art will recognize that the invention can be practiced with modifications within the spirit and scope of the appended claims.

What is claimed is:

1. A faucet comprising:
a valve body comprising a passageway therethrough, an internally threaded opening communicating with the passageway, and a spout at one end of the passageway;
a valve comprising a stainless steel sleeve including an annular flange and a rim extending downward from the flange; a hollow, cylindrical, stainless steel cartridge including external threads extending from one end, a stepped-diameter opening surrounded by the external threads and with the rim seated thereon, two opposite peripheral ports proximate the other end and spaced from the external threads, a lead free annular soldered joint for joining the sleeve, the rim, and one end of the cartridge together, and a first O-ring put on the soldered joint; a stainless steel stem including a gear at one end, a threaded hole surrounding by the gear, a plurality of intermediate second O-rings, and a tab extending downward from the other end to be substantially flush with the ports wherein the stem is partially disposed in both the sleeve and the cartridge and has the gear exposed, and wherein a portion of the stem is further frictionally retained in the sleeve with the second O-rings being rotatably secured to the sleeve; a plastic, disc shaped first retaining member including a diametrical slit; a ceramic, oval second retaining member including two opposite, peripheral cavities and a slot wherein the first retaining member is complimentarily seated upon the second retaining member with the slit aligned with the slot, and the tab inserted through the slit into the slot to lockingly join the stem, the first retaining member, and the second retaining member together; a ceramic, disc shaped abutting member including two opposite, spaced through holes; and a plastic, ring shaped seat for urging the abutting member against the second retaining member wherein the cartridge is supported by the seat; and
a handle comprising a hole with gear-like threads meshed with the gear;
wherein the handle is secured to the stem by driving a fastener through the handle into the threaded hole;
wherein the seat is fastened in the valve body by threadedly securing the external threads to the internally threaded opening so as to anchor the valve in the valve body; and
wherein a rotation of the handle rotates the stem which in turn rotates the second retaining member to either communicate the cavities with the through holes in order to flow fluid through the valve or block the communication of the cavities with the through holes.

2. The faucet of claim 1, wherein the rim has an uneven portion.

3. The faucet of claim 2, wherein the uneven portion of the rim is urged by one of the second O-rings.

4. A process of manufacturing a lead-free valve of a faucet, comprising the steps of:
(a) cutting, shaping, milling, and drilling a blank of stainless steel to form a sleeve with a rim;
(b) cutting, shaping, milling, and drilling a blank of stainless steel to form a cartridge with a bore;
(c) aligning the sleeve with the cartridge to form a housing;
(d) forming external threads on the external surface of an upper portion of the cartridge by milling so as to fasten the cartridge in a valve body by threading;
(e) cutting, shaping, milling, and drilling a blank of stainless steel to form a stem; and
(f) assembling the housing, the stem, a first retaining member, a second retaining member, an abutting member, and a set together to finish the lead-free valve.
